(19) United States
(12) Patent Application Publication
(10) Pub. No.: US 2024/0421869 A1
(43) Pub. Date: Dec. 19, 2024

(54) DYNAMIC CODEBOOK SUBSET RESTRICTION CONFIGURATIONS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US); Wooseok NAM, San Diego, CA (US)

(21) Appl. No.: 18/706,185

(22) PCT Filed: Jan. 17, 2022
(86) PCT No.: PCT/CN2022/072231

§ 371 Date: Apr. 30, 2024

(51) Int. Cl. H04B 7/0456; H04B 7/06; H04W 72/0446

(52) U.S. Cl. CPC H04B 7/0481; H04B 7/0626; H04W 72/0446

(57) ABSTRACT

Various aspects of the present disclosure generally relate to wireless communication. In some aspects, a user equipment (UE) may receive, from a base station, a dynamic codebook subset restriction (CBSR) configuration that indicates time-variant CBSR information associated with a channel state information reference signal (CSI-RS) or synchronization signal block (SSB) resource selection codebook, or with a joint CSI-RS resource and CSI-RS port selection codebook. The UE may transmit, to the base station, channel state information (CSI) feedback that indicates the CSI-RS or SSB resource selection codebook or the joint CSI-RS resource and CSI-RS port selection codebook based at least in part on the dynamic CBSR configuration indicating the time-variant CBSR information. Numerous other aspects are described.

### FIELD OF THE DISCLOSURE

Aspects of the present disclosure generally relate to wireless communication and to techniques and apparatuses for a dynamic codebook subset restriction (CBSR) configurations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, a method of wireless communication performed by a user equipment (UE) includes receiving, from a base station, a dynamic codebook subset restriction (CBSR) configuration that indicates time-variant CBSR information associated with a channel state information reference signal (CSI-RS) or synchronization signal block (SSB) resource selection codebook, or with a joint CSI-RS resource and CSI-RS port selection codebook; and transmitting, to the base station, channel state information (CSI) feedback that indicates the CSI-RS or SSB resource selection codebook or the joint CSI-RS resource and CSI-RS port selection codebook based at least in part on the dynamic CBSR configuration indicating the time-variant CBSR information.

In some implementations, a method of wireless communication performed by a base station includes transmitting, to a UE, a dynamic CBSR configuration that indicates time-variant CBSR information associated with a CSI-RS or SSB resource selection codebook, or with a joint CSI-RS resource and CSI-RS port selection codebook; and receiving, from the UE, CSI feedback that indicates the CSI-RS or SSB resource selection codebook or the joint CSI-RS resource and CSI-RS port selection codebook based at least in part on the dynamic CBSR configuration indicating the time-variant CBSR information.

In some implementations, an apparatus for wireless communication at a UE includes a memory and one or more processors, coupled to the memory, configured to: receive, from a base station, a dynamic CBSR configuration that indicates time-variant CBSR information associated with a CSI-RS or SSB resource selection codebook, or with a joint CSI-RS resource and CSI-RS port selection codebook; and transmit, to the base station, CSI feedback that indicates the CSI-RS or SSB resource selection codebook or the joint CSI-RS resource and CSI-RS port selection codebook based at least in part on the dynamic CBSR configuration indicating the time-variant CBSR information.

In some implementations, an apparatus for wireless communication at a base station includes a memory and one or more processors, coupled to the memory, configured to: transmit, to a UE, a dynamic CBSR configuration that indicates time-variant CBSR information associated with a CSI-RS or SSB resource selection codebook, or with a joint CSI-RS resource and CSI-RS port selection codebook; and receive, from the UE, CSI feedback that indicates the CSI-RS or SSB resource selection codebook or the joint CSI-RS resource and CSI-RS port selection codebook based at least in part on the dynamic CBSR configuration indicating the time-variant CBSR information.

In some implementations, a non-transitory computer-readable medium storing a set of instructions for wireless communication includes one or more instructions that, when executed by one or more processors of a UE, cause the UE to: receive, from a base station, a dynamic CBSR configuration that indicates time-variant CBSR information associated with a CSI-RS or SSB resource selection codebook, or with a joint CSI-RS resource and CSI-RS port selection codebook; and transmit, to the base station, CSI feedback that indicates the CSI-RS or SSB resource selection codebook or the joint CSI-RS resource and CSI-RS port selection codebook based at least in part on the dynamic CBSR configuration indicating the time-variant CBSR information.

In some implementations, a non-transitory computer-readable medium storing a set of instructions for wireless communication includes one or more instructions that, when executed by one or more processors of a base station, cause the base station to: transmit, to a UE, a dynamic CBSR configuration that indicates time-variant CBSR information associated with a CSI-RS or SSB resource selection codebook, or with a joint CSI-RS resource and CSI-RS port selection codebook; and receive, from the UE, CSI feedback that indicates the CSI-RS or SSB resource selection codebook or the joint CSI-RS resource and CSI-RS port selection codebook based at least in part on the dynamic CBSR configuration indicating the time-variant CBSR information.

In some implementations, an apparatus for wireless communication includes means for receiving, from a base station, a dynamic CBSR configuration that indicates time-variant CBSR information associated with a CSI-RS or SSB resource selection codebook, or with a joint CSI-RS resource and CSI-RS port selection codebook; and means for transmitting, to the base station, CSI feedback that indicates the CSI-RS or SSB resource selection codebook or the joint CSI-RS resource and CSI-RS port selection codebook based at least in part on the dynamic CBSR configuration indicating the time-variant CBSR information.

In some implementations, an apparatus for wireless communication includes means for transmitting, to a UE, a dynamic CBSR configuration that indicates time-variant CBSR information associated with a CSI-RS or SSB resource selection codebook, or with a joint CSI-RS resource and CSI-RS port selection codebook; and means for receiving, from the UE, CSI feedback that indicates the CSI-RS or SSB resource selection codebook or the joint CSI-RS resource and CSI-RS port selection codebook based at least in part on the dynamic CBSR configuration indicating the time-variant CBSR information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating examples of beam management procedures, in accordance with the present disclosure.

FIG. 4 is a diagram illustrating examples of beam measurement and reporting, in accordance with the present disclosure.

FIG. 5 is a diagram illustrating examples of a resource selection codebook, in accordance with the present disclosure.

FIG. 6 is a diagram illustrating examples associated with dynamic codebook subset restriction (CBSR) configurations, in accordance with the present disclosure.

FIG. 7 is a diagram illustrating examples associated with dynamic CBSR configurations for channel state information reference signal (CSI-RS) and synchronization signal block (SSB) resource selection codebooks, in accordance with the present disclosure.

FIGS. 8A-8D are diagrams illustrating examples associated with CBSR patterns associated with different rank combinations, in accordance with the present disclosure.

FIGS. 9-10 are diagrams illustrating example processes associated with dynamic CBSR configurations for CSI-RS and SSB resource selection codebooks, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

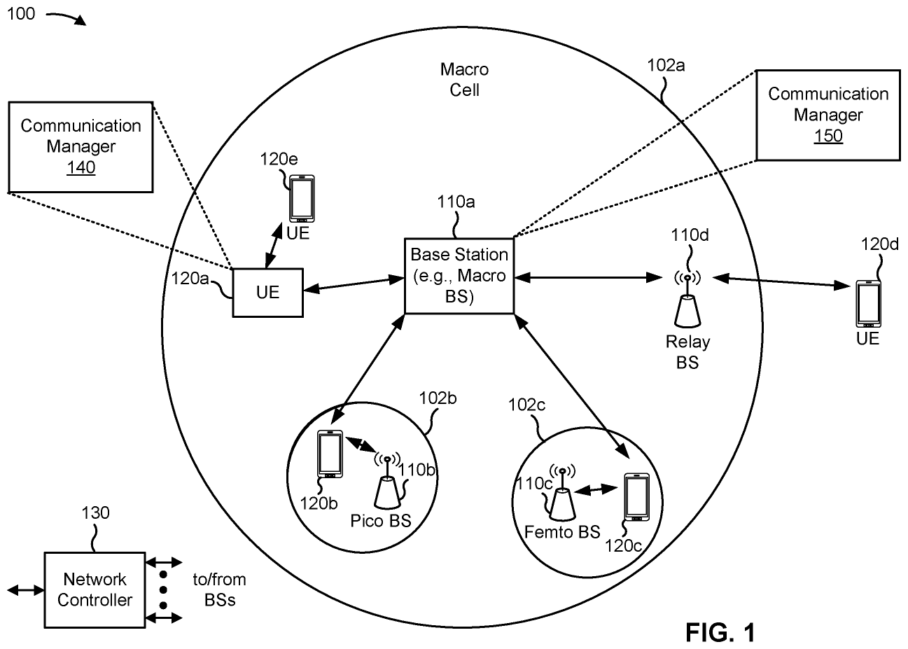

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a base station, a dynamic codebook subset restriction (CBSR) configuration that indicates time-variant CBSR information associated with a channel state information reference signal (CSI-RS) or synchronization signal block (SSB) resource selection codebook, or with a joint CSI-RS resource and CSI-RS port selection codebook; and transmit, to the base station, channel state information (CSI) feedback that indicates the CSI-RS or SSB resource selection codebook or the joint CSI-RS resource and CSI-RS port selection codebook based at least in part on the dynamic CBSR configuration indicating the time-variant CBSR information. Additionally, or alternatively, the communication manager 140 may perform one or more other operations described herein.

In some aspects, a base station (e.g., base station 110) may include a communication manager 150. As described in more detail elsewhere herein, the communication manager 150 may transmit, to a UE, a dynamic CBSR configuration that indicates time-variant CBSR information associated with a CSI-RS or SSB resource selection codebook, or with a joint CSI-RS resource and CSI-RS port selection codebook; and receive, from the UE, CSI feedback that indicates the CSI-RS or SSB resource selection codebook or the joint CSI-RS resource and CSI-RS port selection codebook based at least in part on the dynamic CBSR configuration indicating the time-variant CBSR information. Additionally, or alternatively, the communication manager 150 may perform one or more other operations described herein.

As indicated above, FIG. 1 is provided as an example. Other examples may differ from what is described with regard to FIG. 1.

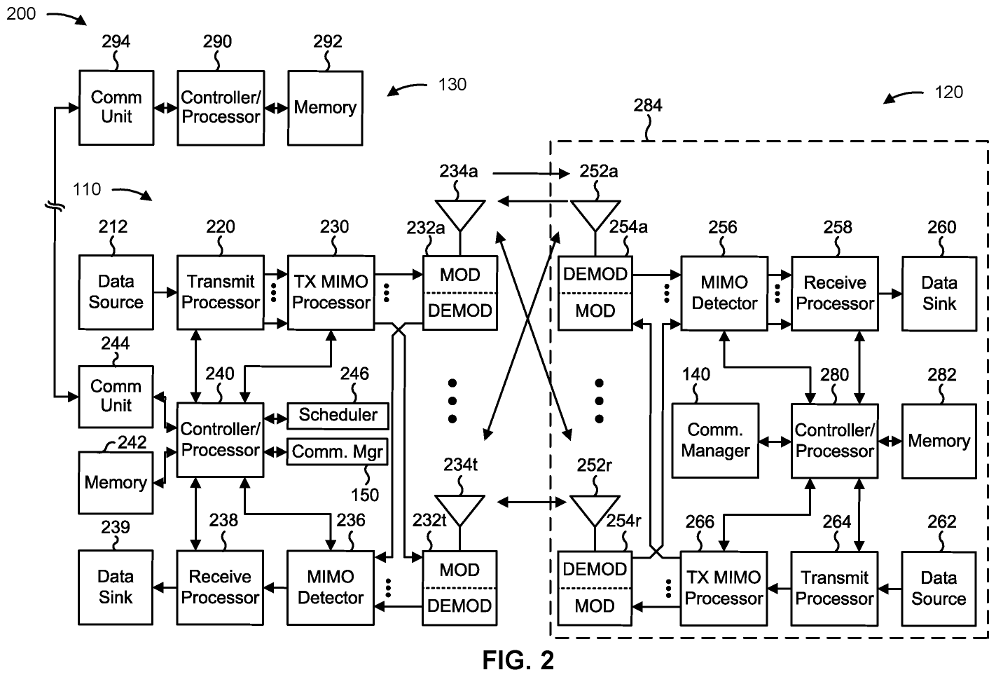

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

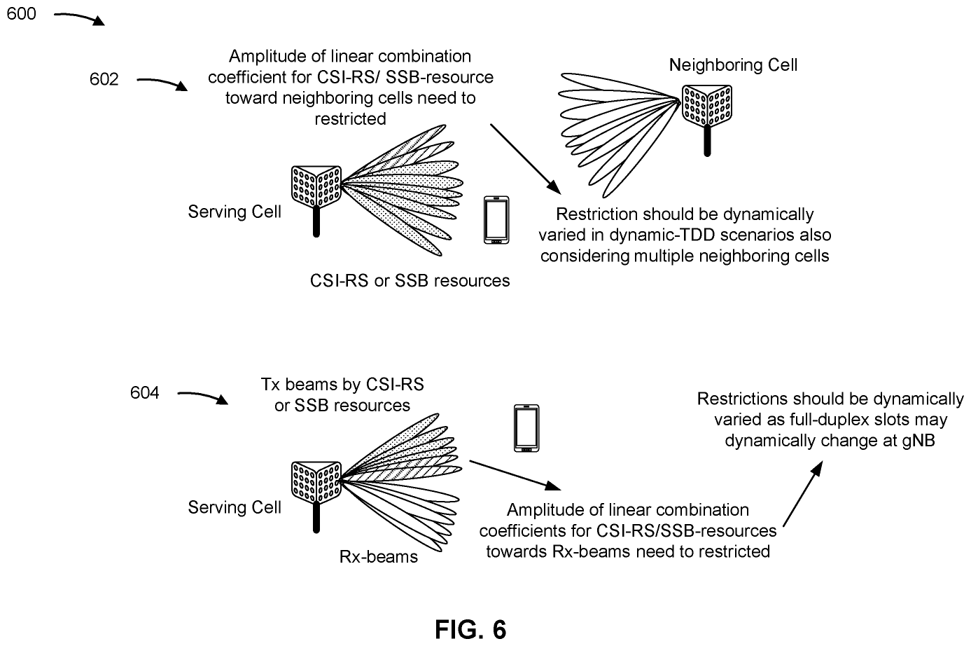

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-12).

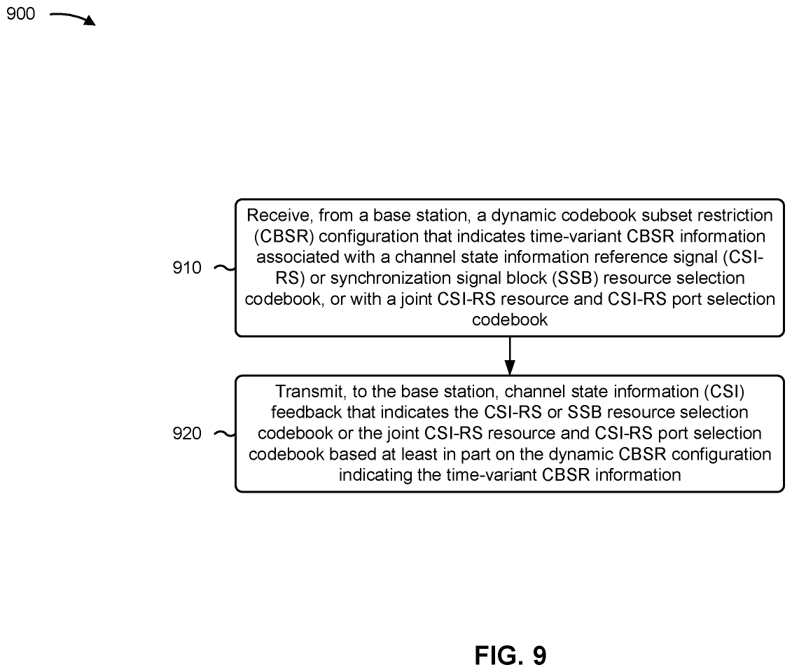

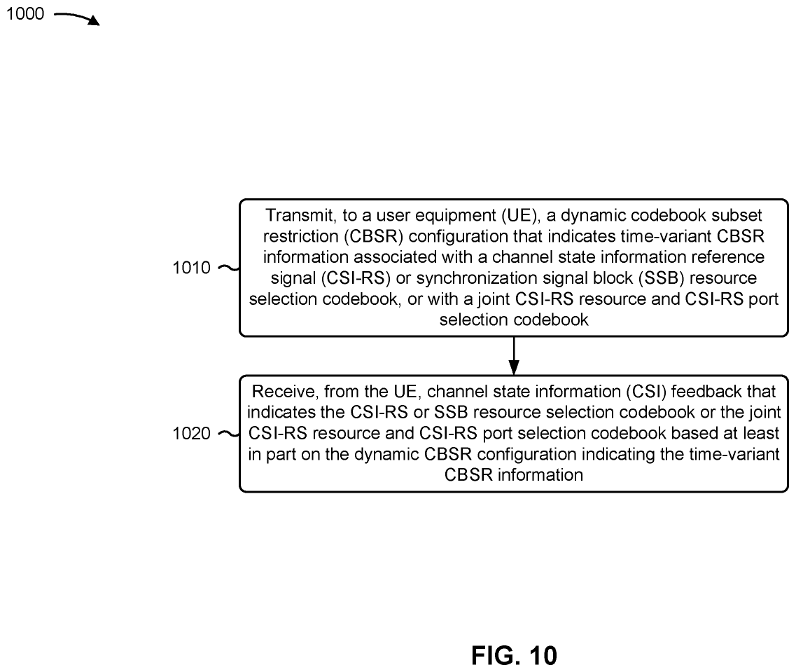

The controller/processor 240 of the base station 110, the controller/processor 280 of the UE 120, and/or any other component(s) of FIG. 2 may perform one or more techniques associated with dynamic CBSR configurations for CSI-RS and SSB resource selection codebooks, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a base station, a dynamic CBSR configuration that indicates time-variant CBSR information associated with a CSI-RS or SSB resource selection codebook, or with a joint CSI-RS resource and CSI-RS port selection codebook; and/or means for transmitting, to the base station, CSI feedback that indicates the CSI-RS or SSB resource selection codebook or the joint CSI-RS resource and CSI-RS port selection codebook based at least in part on the dynamic CBSR configuration indicating the time-variant CBSR information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a base station (e.g., base station 110) includes means for transmitting, to a UE, a dynamic CBSR configuration that indicates time-variant CBSR information associated with a CSI-RS or SSB resource selection codebook, or with a joint CSI-RS resource and CSI-RS port selection codebook; and/or means for receiving, from the UE, CSI feedback that indicates the CSI-RS or SSB resource selection codebook or the joint CSI-RS resource and CSI-RS port selection codebook based at least in part on the dynamic CBSR configuration indicating the time-variant CBSR information. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

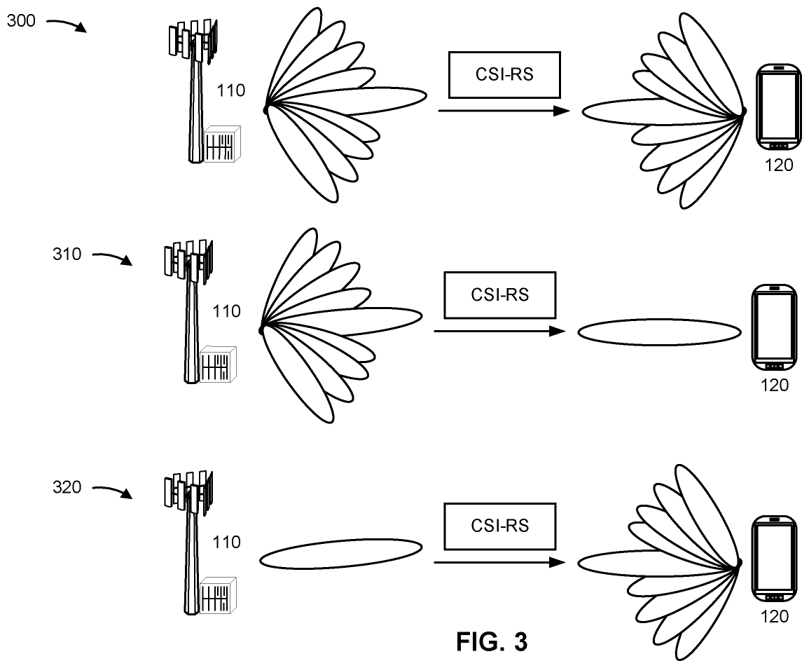

FIG. 3 is a diagram illustrating examples 300, 310, and 320 of CSI-RS beam management procedures, in accordance with the present disclosure. As shown in FIG. 3, examples 300, 310, and 320 include a UE 120 in communication with a base station 110 in a wireless network (e.g., wireless network 100). However, the devices shown in FIG. 3 are provided as examples, and the wireless network may support communication and beam management between other devices (e.g., between a UE 120 and a base station 110 or TRP). In some aspects, the UE 120 and the base station 110 may be in a connected state (e.g., a radio resource control (RRC) connected state).

As shown in FIG. 3, example 300 may include a base station 110 and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the base station 110 to the UE 120. The CSI-RSs may be configured to be periodic (e.g., using RRC signaling), semi-persistent (e.g., using media access control (MAC) control element (CE) (MAC-CE) signaling), and/or aperiodic (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 300 has been described in connection with CSI-RSs, the first beam management process may also use SSBs for beam management in a similar manner as described above. For example, UE 120 and base station 110 may perform SSB beam sweeping (e.g., during initial access along with SSB and random access channel (RACH) association) to select a beam pair with a course granularity (e.g., by using wider, layer 1 (L1) beams) before performing CSI-RS beam sweeping (e.g., in a connected mode) to select a beam pair with a finer granularity (e.g., using hierarchical beam refinement).

As shown in FIG. 3, example 310 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a hierarchical beam refinement procedure (e.g., a P1, P2, or P3 procedure), a base station beam refinement procedure, a TRP beam refinement procedure, and/or a transmit beam refinement procedure. As shown in FIG. 3 and example 310, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120. In some cases, UE 120 may report a linear combination of beamformed CSI-RS ports as a precoding matrix indicator (PMI). Additionally, or alternatively, in some frequency ranges, such as FR2, base station 110 may generate a linear combination of a set of beams to form a new beam (e.g., a CSI-RS may be a linear combination of multiple SSB beams). For example, base station 110 may transmit a first beam (e.g., an SSB) with a first basis b₁ and a second beam (e.g., an SSB) with a second basis b₂ and UE 120 may identify a preferred beam as a linear combination of the beams, c₁b₁+c₂b₂, where c represents a quantized coefficient for a beam. In this case, UE 120 may report indices of the beams (e.g., b₁ and b₂) and the quantized coefficients c₁ and c₂ from which base station 110 may derive a preferred beam for UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams). In some cases, beam failure recovery procedures may be used to recover a beam after a detected beam failure or radio link failure procedures may be used to identify a new beam after a detected beam or radio link failure.

In some cases, UE 120 and base station 110 may use beam prediction to reduce a quantity of beam measurements associated with selecting a beam (e.g., in one or more of the aforementioned beam management procedures). For example, when beam prediction is not used, UE 120 and base station 110 may communicate (e.g., by transmitting a CSI-RS and performing measurements and by reporting the measurements) on each beam across a beam sweep. However, when beam prediction is used, base station 110 and UE 120 may forgo transmission or measurement of one or more beams of the beam sweep. For example, for a set of consecutive beams (e.g., with regard to beam angle) that are configured for base station 110, base station 110 may forgo transmission of one or more beams within the set of consecutive beams. In this case, base station 110 may completely forgo one or more beam transmissions or may selectively transmit one or more beams based at least in part on whether UE 120 is performing initial access or not or based at least in part on how recently the one or more beams were transmitted. Additionally, or alternatively, base station 110 may transmit all of the beams in the set of consecutive beams, but UE 120 may forgo measurement of one or more beams within the set of consecutive beams. In these cases, base station 110 and/or UE 120 may interpolate (e.g., using artificial intelligence or another prediction technique) from measured beams to predict beam measurements (e.g., an RSRP) for one or more beams that have not been transmitted and/or measured.

Similarly, base station 110 and/or UE 120 may forgo transmission and measurement of beams with a higher granularity. For example, rather than a first beam management procedure using wide beams and a second beam management procedure using narrow beams, base station 110 may forgo transmission and/or UE 120 may forgo measurement of the narrow beams. In this case, base station 110 and/or UE 120 may predict beam measurements for the narrow beams (e.g., that have not been transmitted and/or measured) based at least in part on beam measurements of the wide beams (e.g., that have been transmitted and measured) and/or based at least in part on past beam predictions or measurements. In these ways, base station 110 and/or UE 120 reduce a quantity of UE-side beam measurements and/or a UE-specific communication overhead, thereby improving UE performance and/or network performance.

As indicated above, FIG. 3 is provided as an example of beam management procedures. Other examples of beam management procedures may differ from what is described with respect to FIG. 3. For example, the UE 120 and the base station 110 may perform the third beam management procedure before performing the second beam management procedure, and/or the UE 120 and the base station 110 may perform a similar beam management procedure to select a UE transmit beam.

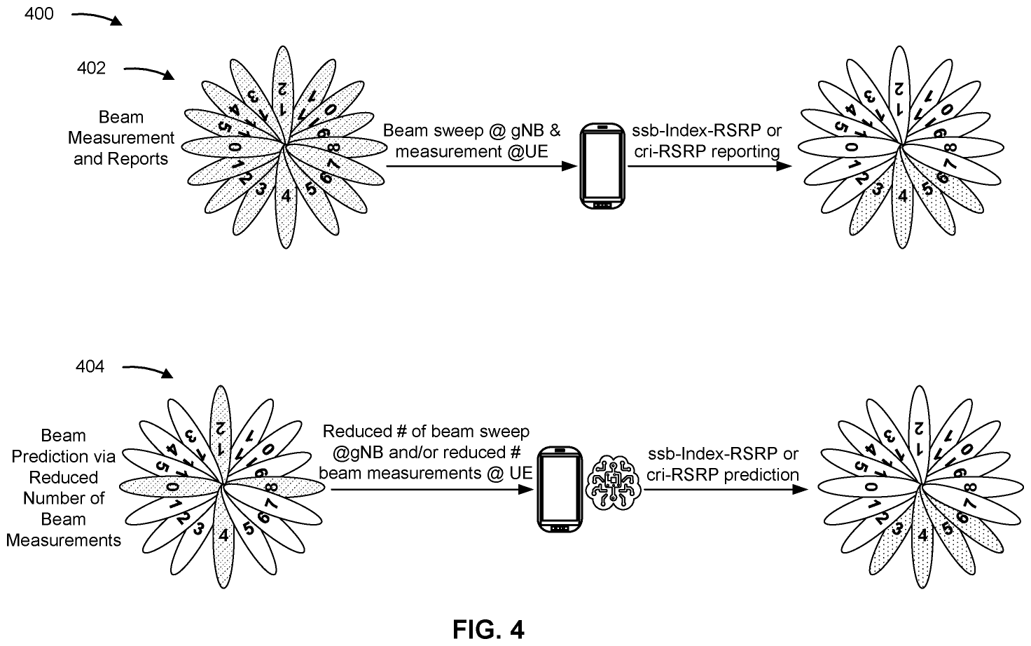

FIG. 4 is a diagram illustrating examples 400 of beam measurement and reporting, in accordance with the present disclosure.

As shown by reference number 402, a base station may perform beam sweeping using a plurality of beams (e.g., 12 beams). The UE may perform beam measurements associated with each of the plurality of beams, and the UE may perform an SSB index RSRP reporting or a CSI-RS resource indicator (CRI) RSRP reporting based at least in part on the beam measurements.

As shown by reference number 404, a UE may use a reduced quantity of beam measurements for beam selection and prediction. A base station may perform a beam sweeping using a subset of a plurality of beams (e.g., 4 beams of a 12 total beams). Other beams may not be transmitted, may be initially or occasionally transmitted, or may be still transmitted but may be measured occasionally by the UE. The base station may performed a reduced quantity of beam sweeping using the subset of the plurality of beams. The UE may perform a reduced quantity of beam measurements. The UE may perform the beam selection and prediction via the reduced quantity of beam measurements, for example, using artificial intelligence and/or machine learning. The UE may perform an SSB index RSRP reporting or a CRI RSRP reporting based at least in part on the reduced quantity of beam measurements.

As indicated above, FIG. 4 is provided as an example. Other examples may differ from what is described with regard to FIG. 4.

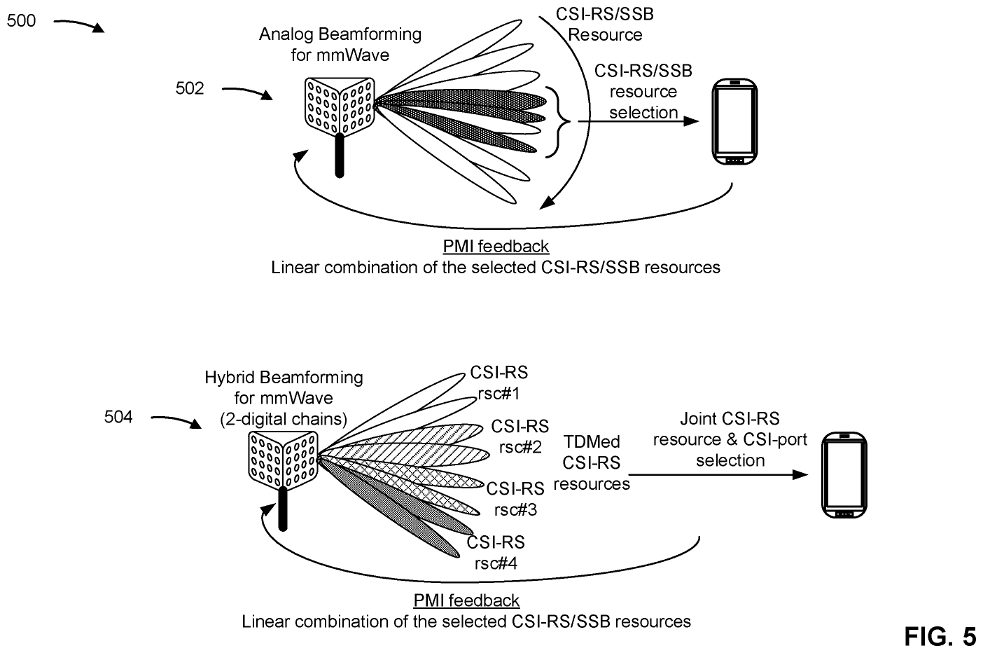

FIG. 5 is a diagram illustrating examples 500 of a resource selection codebook, in accordance with the present disclosure.

As shown by reference number 502, a base station may perform analog beamforming (e.g., in mmWave or FR2). The base station may transmit, to a UE, a plurality of CSI-RSs/SSBs using a plurality of transmit beams, respectively. The CSI-RSs or SSBs may be associated with CSI-RS/SSB resources. The UE may perform a CSI-RS/SSB resource selection based at least in part on the plurality of CSI-RSs/SSBs. The UE may transmit, to the base station, PMI feedback that indicates a CSI-RS/SSB resource selection codebook. The PMI feedback may be based at least in part on a linear combination of selected CSI-RS/SSB resources. The PMI feedback indicating the CSI-RS/SSB resource selection codebook may be wideband-specific or sub-band-specific.

As shown by reference number 504, a base station may perform a hybrid beamforming (e.g., in mmWave or FR2) using two digital chains. The base station may transmit, to a UE, a plurality of CSI-RSs using a plurality of transmit beams, respectively. The CSI-RSs may be associated with CSI-RS resources (e.g., CSI-RS resource #1, CSI-RS resource #2, CSI-RS resource #3, or CSI-RS resource #4) and CSI-RS ports. Each CSI-RS resource may be associated with a set of CSI-RS ports. The CSI-RS ports may be code division multiplexed (CDM) or frequency division multiplexed (FDM). The CSI-RS resources may be time division multiplexed (TDM). The UE may perform a joint CSI-RS resource and CSI-RS port selection based at least in part on the plurality of CSI-RSs. The UE may transmit, to the base station, PMI feedback that indicates a joint CSI-RS resource and CSI-RS port selection codebook. The PMI feedback indicating the joint CSI-RS resource and CSI-RS port selection codebook may be wideband-specific or sub-band-specific.

As an example, for UEs configured in accordance with 3GPP Release 15 (Rel-15), sub-band-specific PMI feedback may include a sub-band-specific coefficient report (e.g., identifying one or more quantized coefficients of one or more beams). This may be termed a “Rel-15 Type-II” coefficient feedback scheme. The Rel-15 Type-II PMI codebook may have a structure of W=W₁W₂, where

$${W}_{1} = [ \begin{matrix}B & 0 \\ 0 & B\end{matrix} ] ,$$

which may correspond to

$$W = [ \begin{matrix}{\tilde{w}}_{0 , 0} \\ {\tilde{w}}_{1 , 0}\end{matrix} ] = {W}_{1} {W}_{2}$$

for rank 1 (with W being normalized to 1) and

$$W = [ \begin{matrix}{\tilde{w}}_{0 , 0} & {\tilde{w}}_{0 , 1} \\ {\tilde{w}}_{1 , 0} & {\tilde{w}}_{1 , 1}\end{matrix} ] = {W}_{1} {W}_{2}$$

for rank 2 (with W being normalized to 1/\sqrt{ }2). A weighted combination of L beams may take the form of \tilde{w}_{r,l}=Σᵢ₌₀^{L-1} bₖ_{₁}_{⁽ⁱ⁾}ₖ_{₂}_{⁽ⁱ⁾}·p_{r,l,i}^{(WB)}·p_{r,l,i}^{(SB)}·c_{r,l,i}, where L is a configurable value, b represents an oversampled 2D discrete Fourier transform (DFT) beam, r represents a polarization value, l represents a layer, p represents a wideband (WB) or sub-band (SB) scaling factor, and c is a beam combining coefficient. As another example, for UEs configured in accordance with 3GPP Release 16 (Rel-16), sub-band-specific PMI feedback may be subject to full-duplex (FD) compression and include a sub-band-specific coefficient report. This may be termed a “Rel-16 eType-II” coefficient scheme.

As indicated above, FIG. 5 is provided as an example. Other examples may differ from what is described with regard to FIG. 5.

In Rel-15/16, a CBSR may be specified by limiting an average/maximum coefficient amplitude to a certain level for Type-II & eType-II codebooks. The CBSR may be applied to spatial DFT beams or CSI-RS ports, when a CSI-RS port selection codebook was used. In Rel-15/16, the CBSR may be applied as a static CBSR, since the CBSR may be applied to codebooks more suitable for FR1. However, with CBSR and CSI-RS/SSB resource selection codebooks, and in applications such as base station full-duplex or dynamic time division duplex (TDD) operations in mmWave or FR2, interference may be spatially and dynamically encountered. As a result, for these applications, the static CBSR may not be suitable for CSI-RS/SSB resource selection codebooks. Further, with CBSR and CSI-RS/SSB resource selection codebooks, linear combination coefficients applied on certain CSI-RS/SSB resources may need to be more dynamically configured, which may not be possible using the static CBSR.

In various aspects of techniques and apparatuses described herein, a UE may receive, from a base station, a dynamic CBSR configuration that indicates time-variant CBSR information. The time-variant CBSR information may be associated with a CSI-RS or SSB resource selection codebook, or the time-variant CBSR information may be associated with a joint CSI-RS resource and CSI-RS port selection codebook. The time-variant CBSR information may indicate a limitation pattern of an amplitude of a linear combination coefficient for a time unit. The UE may transmit, to the base station, CSI feedback that indicates the CSI-RS or SSB resource selection codebook or the joint CSI-RS resource and CSI-RS port selection codebook based at least in part on the dynamic CBSR configuration indicating the time-variant CBSR information.

In some aspects, dynamic CBSR configurations may be used for CSI-RS/SSB resource selection codebooks, which may be useful for Rel-18/19 full-duplex/artificial intelligence scenarios in FR2, and for FR2 dynamic TDD scenarios. As a result, linear combination coefficients applied on certain CSI-RS/SSB resources may be dynamically configured for the UE, which may be useful for certain applications such as base station full-duplex or dynamic TDD operations, in which interference may be spatial and dynamic.

FIG. 6 is a diagram illustrating examples 600 associated with dynamic CBSR configurations, in accordance with the present disclosure.

As shown by reference number 602, a base station associated with a serving cell may transmit a plurality of CSI-RSs or SSBs associated with CSI-RS/SSB resources. An amplitude of linear combination coefficients for CSI-RS/SSB resources towards neighboring cells may need to be restricted, due to dynamic TDD operations. A dynamic CBSR configuration may dynamically vary codebook subset restrictions in dynamic TDD scenarios, while also considering multiple neighboring cells.

As shown by reference number 604, a base station may transmit a plurality of CSI-RSs or SSBs associated with CSI-RS/SSB resources, where the plurality of CSI-RSs or SSBs may be associated with different transmit beams. An amplitude of linear combination coefficients for CSI-RS/SSB resources towards receive beams of the base station may need to be restricted, due to base station full-duplex operations. A dynamic CBSR configuration may dynamically vary codebook subset restrictions, as full-duplex slots may dynamically change at the base station.

As indicated above, FIG. 6 is provided as an example. Other examples may differ from what is described with regard to FIG. 6.

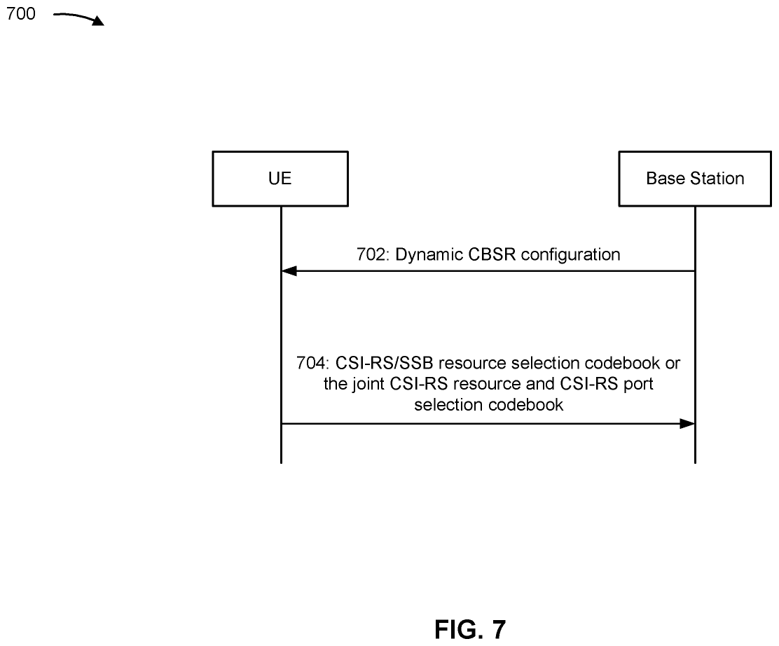

FIG. 7 is a diagram illustrating an example 700 associated with dynamic CBSR configurations for CSI-RS and SSB resource selection codebooks, in accordance with the present disclosure. As shown in FIG. 7, example 700 includes communication between a UE (e.g., UE 120) and a base station (e.g., base station 110). In some aspects, the UE and the base station may be included in a wireless network, such as wireless network 100.

As shown by reference number 702, the UE may receive a dynamic CBSR configuration from the base station. The dynamic CBSR configuration may indicate time-variant CBSR information. The UE may receive the dynamic CBSR configuration via RRC signaling, a MAC-CE, or DCI. In other words, the UE may be RRC configured and/or MAC-CE/DCI activated/indicated with the time-variant CBSR information, which may be associated with a CSI-RS/SSB resource selection codebook or a joint CSI-RS resource and CSI-RS port selection codebook.

In some aspects, the dynamic CBSR configuration may indicate a CSI-RS/SSB resource specific CBSR. The CBSR information may include limitation patterns associated with different time units on an amplitude of linear combination coefficient(s) associated with one or more selected CSI-RS/SSB resources for the CSI-RS/SSB resource selection codebook, and/or CSI-RS ports associated with one or more selected CSI-RS resources for the joint CSI-RS resource and CSI-RS port selection codebook. The different time units may be based at least in part on symbols, symbol-groups, sub-slots, half-slots, slots, mini-slots, half-subframes, subframes, half-frames, and/or frames. The different time slots may be associated with slots indicating a CSI report itself, or slots with a configured offset associated with the slots indicating the CSI report. In other words, time units may be associated with CSI report slots, or slots with offsets from the CSI report slots.

In some aspects, the time-variant CBSR information may be configured/indicated using one of three options. In a first option, RRC signaling may configure semi-statically or periodically applied CBSR patterns associated with different time units. The RRC signaling (or RRC configuration) may be included in a periodic or semi-persistent CSI report indicating the CSI-RS/SSB resource selection codebook or the joint CSI-RS resource and CSI-RS port selection codebook.

In some aspects, in a second option, RRC signaling may configure multiple CBSR patterns associated with different time units, and a MAC-CE may activate/deactivate at least one of the multiple CBSR patterns. The RRC signaling (or RRC configuration) may be included in a semi-persistent CSI report indicating the CSI-RS/SSB resource selection codebook or the joint CSI-RS resource and CSI-RS port selection codebook. The MAC-CE may be a same MAC-CE that activates/deactivates the semi-persistent CSI report, when activating/deactivating a certain CBSR pattern. In some cases, the MAC-CE may be a separate MAC-CE for deactivating a certain CBSR pattern (and in some cases, for activating an alternative CBSR pattern).

In some aspects, in a third option, RRC signaling may configure multiple CBSR patterns associated with different time units, and DCI may trigger/deactivate at least one of the multiple CBSR patterns. The RRC signaling (or RRC configuration) may be included in an aperiodic or semi-persistent CSI report indicating the CSI-RS/SSB resource selection codebook or the joint CSI-RS resource and CSI-RS port selection codebook. The DCI may be a DCI triggering the aperiodic or semi-persistent CSI report, when triggering a certain CBSR pattern. The DCI may be a DCI releasing a certain semi-persistent CSI report (e.g., a CSI report that indicates triggering states currently active), when deactivating a certain CBSR pattern. The DCI may be a separate DCI that deactivates a certain CBSR pattern (and in some cases, for activating an alternative CBSR pattern).

In some aspects, the time-variant CBSR information may be associated with full-duplex operations. The time-variant CBSR information may indicate full-duplex CBSR patterns associated with periodic or semi-persistent or dynamic configured/indicated full-duplex resource patterns, which may be further based at least in part on a CBSR usage dedicated for a purpose of base station full-duplex operations. As an example, for time-selective full-duplex (e.g., only selective slots may be used for base station full-duplex operations), CBSR patterns may only be applied when a configured slot offset associated with a slot indicating a CSI report leads to a full-duplex slot. As another example, for dynamic full-duplex (e.g., a base station may dynamically determine which slots may be used for base station full-duplex based at least in part on a base station implementation), the UE may be indicated in a DCI triggering a CSI-report that a CBSR associated with a full-duplex usage should be considered when reporting PMI. In some aspects, a full-duplex CBSR pattern may indicate an RRC configured periodic or semi-persistent full-duplex resource patterns (e.g., periodical full-duplex slots patterns) and/or MAC-CE/DCI indicated full-duplex resource pattern (e.g., dynamically adjusted full-duplex slots patterns).

In some aspects, the UE may be configured with different CBSR patterns associated with different rank combinations. In other words, the UE may be configured with a rank combination specific CBSR. For rank combinations, at least two sets of ranks may be reported that are respectively associated with two sets of CSI-RS/SSB resources (e.g., different CSI-RS/SSB resources may be transmitted from different panels or TRPs).

In some aspects, the different CBSR patterns associated with the different rank combinations may be jointly used with time-variant CBSR patterns. For example, a grouping of CSI-RS resources may be varied across different time units. As another example, limitations on coefficient amplitudes may be varied across different time units.

As shown by reference number 704, the UE may transmit, to the base station, the CSI-RS/SSB resource selection codebook or the joint CSI-RS resource and CSI-RS port selection codebook based at least in part on the dynamic CBSR configuration. In other words, the UE may transmit the CSI-RS/SSB resource selection codebook or the joint CSI-RS resource and CSI-RS port selection codebook based at least in part on the time-variant CBSR information indicated in the dynamic CBSR configuration.

As indicated above, FIG. 7 is provided as an example. Other examples may differ from what is described with regard to FIG. 7.

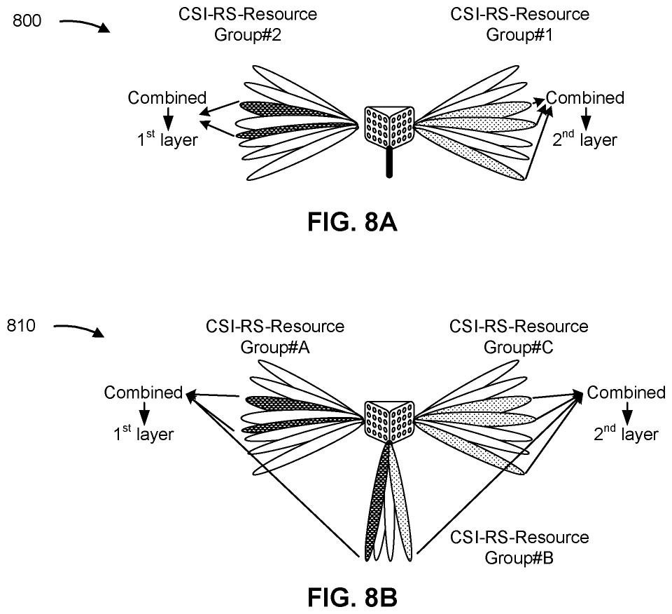

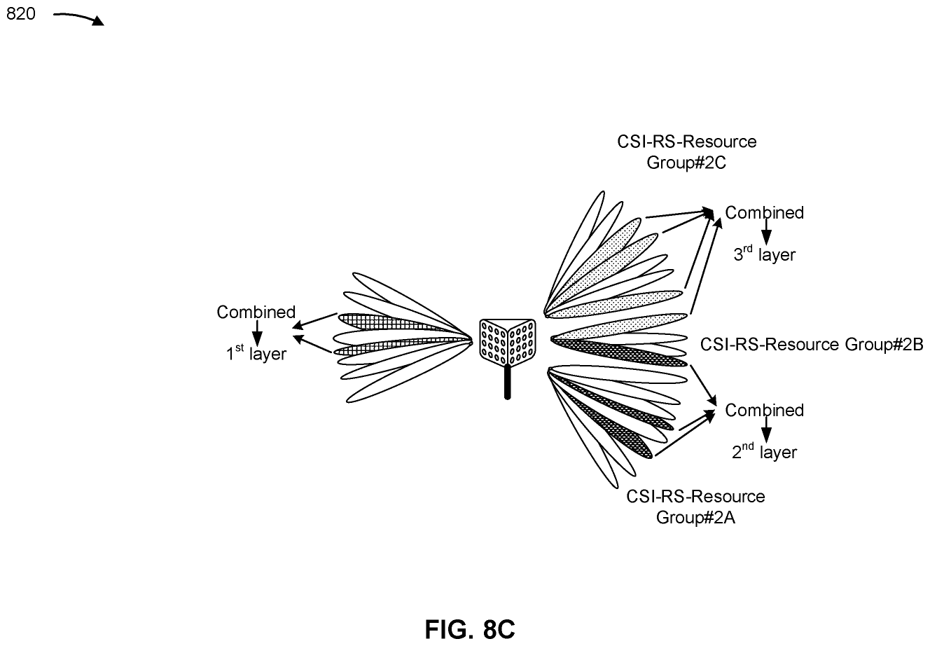

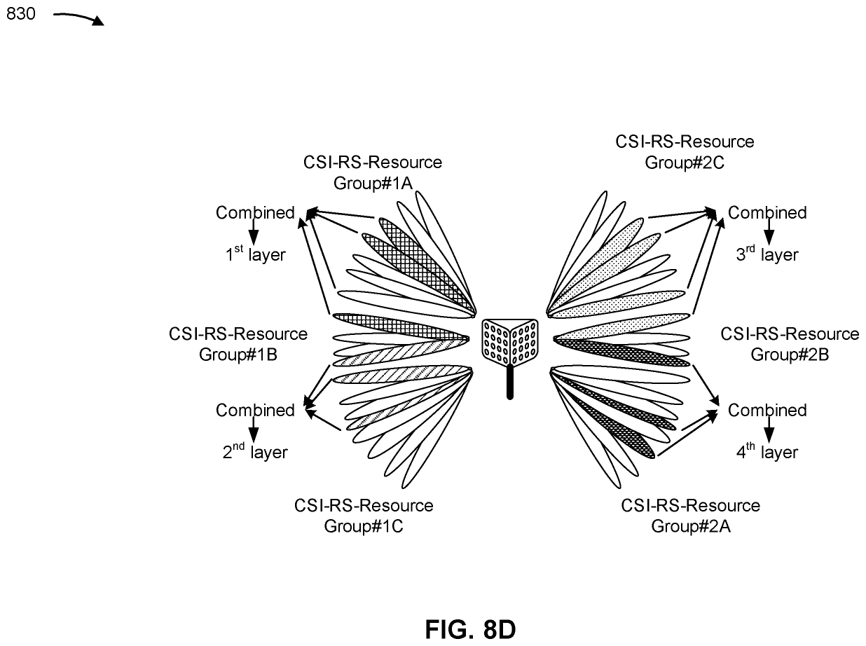

FIGS. 8A-8D are diagrams illustrating examples 800, 810, 820, 830 associated with CBSR patterns associated with different rank combinations, in accordance with the present disclosure.

As shown in FIG. 8A, for a rank-1 and rank-1 PMI, a CBSR may specify that a first linear combination of CSI-RS resources within a first CSI-RS/SSB resource group may be associated with a first layer, while CSI-RS resources within a second CSI-RS/SSB resource group may be associated with a second layer. Linear combinations across the first CSI-RS/SSB resource group and the second CSI-RS/SSB resource group may not be allowed. Further, separate ranks may be transmitted from two separate panels.

As shown in FIG. 8B, for a rank-1 and rank-1 PMI, a CBSR may specify that CSI-RS resources may be further separated into a subgroup-A, a subgroup-B, and a subgroup-C, such that a first layer may be associated with a linear combination of CSI-RS/SSB resources within subgroup-A and subgroup-B, and a second layer may be associated with a linear combination of CSI-RS/SSB resources within subgroup-B and subgroup-C. Linear combinations across subgroup-A and subgroup-C may not be allowed. Further, two layers may be transmitted from a single panel, but certain CSI-RS/SSB resources may be unable to be shared among different layers (e.g., due to analog/hybrid beamforming).

As shown in FIG. 8C, for a rank-1 and rank-1 PMI, a CBSR may specify that a first linear combination of CSI-RS resources within a first CSI-RS/SSB resource group may be associated with a first layer. CSI-RS resources within a second CSI-RS/SSB resource group may be further separated into a subgroup-2A, a subgroup-2B, and a subgroup-2C, such that a second layer must be associated with a linear combination of CSI-RS/SSB resources within subgroup-2A and subgroup-2B, and a third layer may be associated with a linear combination of CSI-RS/SSB resources within subgroup-2B and subgroup-2C. Linear combinations across subgroup-2A and subgroup-2C may not be allowed. Further, the first layer may be transmitted from a first panel in which transmitted CSI-RS/SSB resources (e.g., all transmitted CSI-RS/SSB resources) are linearly combinable, while the second layer and the third layer may be transmitted from a second panel, but certain CSI-RS/SSB resources may be unable to be shared among different layers (e.g., due to analog/hybrid beamforming).

As shown in FIG. 8D, for a rank-2 and rank-2 PMI, a CBSR may specify that a CSI-RS resource within a first CSI-RS/SSB resource group may be further separated into a subgroup-1A, a subgroup-1B, and a subgroup-1C, such that a first layer may be associated with a linear combination of CSI-RS SSB/resources within subgroup-1A and subgroup-1B, and a second layer may be associated with a linear combination of CSI-RS/SSB resources within subgroup-1B and subgroup-1C. CSI-RS resources within a second CSI-RS/SSB resource group may be further separated into a subgroup-2A, a subgroup-2B, and a subgroup-2C, such that a third layer may be associated with a linear combination of CSI-RS/SSB resources within subgroup-2A and subgroup-2B, and a fourth layer may be associated with a linear combination of CSI-RS/SSB resources within subgroup-2B and subgroup-2C. Linear combinations across subgroup-2A and subgroup-2C may not be allowed. Further, the two groups of two layers may be transmitted from a first panel and a second panel, but certain CSI-RS/SSB resources may be unable to be shared among different layers even within a certain panel (e.g., due to analog/hybrid beamforming).

As indicated above, FIGS. 8A-8B are provided as examples. Other examples may differ from what is described with regard to FIGS. 8A-8B.

FIG. 9 is a diagram illustrating an example process 900 performed, for example, by a UE, in accordance with the present disclosure. Example process 900 is an example where the UE (e.g., UE 120) performs operations associated with dynamic CBSR configurations.

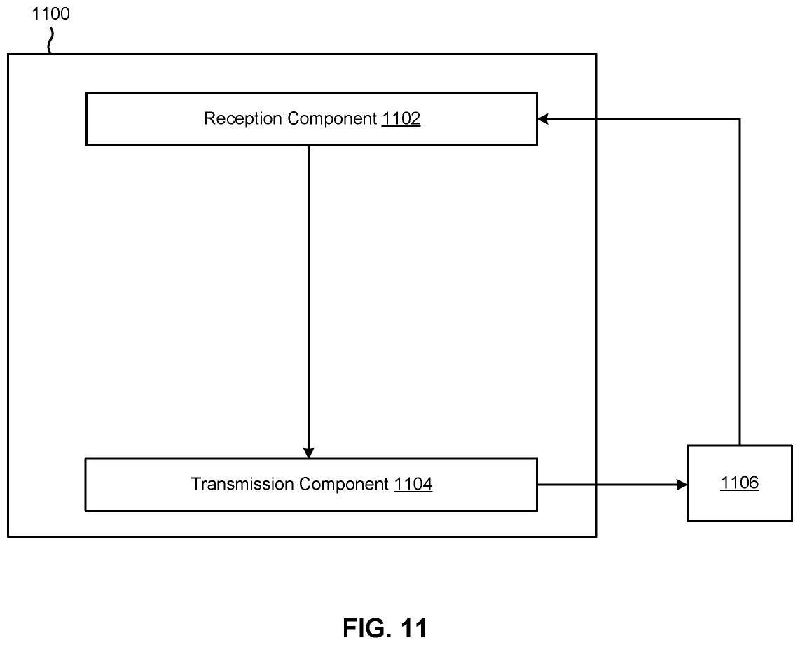

As shown in FIG. 9, in some aspects, process 900 may include receiving, from a base station, a dynamic CBSR configuration that indicates time-variant CBSR information associated with a CSI-RS or SSB resource selection codebook, or with a joint CSI-RS resource and CSI-RS port selection codebook (block 910). For example, the UE (e.g., using reception component 1102, depicted in FIG. 11) may receive, from a base station, a dynamic CBSR configuration that indicates time-variant CBSR information associated with a CSI-RS or SSB resource selection codebook, or with a joint CSI-RS resource and CSI-RS port selection codebook, as described above.

As further shown in FIG. 9, in some aspects, process 900 may include transmitting, to the base station, CSI feedback that indicates the CSI-RS or SSB resource selection codebook or the joint CSI-RS resource and CSI-RS port selection codebook based at least in part on the dynamic CBSR configuration indicating the time-variant CBSR information (block 920). For example, the UE (e.g., using transmission component 1104, depicted in FIG. 11) may transmit, to the base station, CSI feedback that indicates the CSI-RS or SSB resource selection codebook or the joint CSI-RS resource and CSI-RS port selection codebook based at least in part on the dynamic CBSR configuration indicating the time-variant CBSR information, as described above.

Process 900 may include additional aspects, such as any single aspect or any combination of aspects described below and/or in connection with one or more other processes described elsewhere herein.

In a first aspect, the time-variant CBSR information indicates a limitation pattern of an amplitude of a linear combination coefficient for a time unit.

In a second aspect, alone or in combination with the first aspect, the limitation pattern of the amplitude of the linear combination coefficient is associated with one or more selected CSI-RS or SSB resources for the CSI-RS or SSB resource selection codebook.

In a third aspect, alone or in combination with one or more of the first and second aspects, the limitation pattern of the amplitude of the linear combination coefficient is associated with CSI-RS ports associated with one or more selected CSI-RS or SSB resources for the joint CSI-RS resource and CSI-RS port selection codebook.

In a fourth aspect, alone or in combination with one or more of the first through third aspects, the time unit is based at least in part on one or more of a symbol, a symbol group, a sub-slot, a half-slot, a slot, a mini-slot, a half-subframe, a subframe, a half-frame, or a frame.

In a fifth aspect, alone or in combination with one or more of the first through fourth aspects, the time unit is associated with a slot that indicates the CSI feedback, or wherein the time unit is associated with a slot with a configured offset associated with the slot that indicates the CSI feedback.

In a sixth aspect, alone or in combination with one or more of the first through fifth aspects, receiving the dynamic CBSR configuration that indicates the time-variant CBSR information is based at least in part on one or more of RRC signaling, a MAC-CE, or DCI.

In a seventh aspect, alone or in combination with one or more of the first through sixth aspects, the time-variant CBSR information is configured or indicated based at least in part on RRC signaling that configures semi-statically or periodically applied CBSR patterns associated with different time units.

In an eighth aspect, alone or in combination with one or more of the first through seventh aspects, the time-variant CBSR information is configured or indicated based at least in part on RRC signaling that configures multiple CBSR patterns associated with different time units, and a MAC-CE that activates or deactivates at least one of the multiple CBSR patterns.

In a ninth aspect, alone or in combination with one or more of the first through eighth aspects, the time-variant CBSR information is configured or indicated based at least in part on RRC signaling that configures multiple CBSR patterns associated with different time units, and DCI that triggers or deactivates at least one of the multiple CBSR patterns.

In a tenth aspect, alone or in combination with one or more of the first through ninth aspects, the time-variant CBSR information indicates a full-duplex resource pattern, and wherein the full-duplex resource pattern is based at least in part on a CBSR usage dedicated for a base station full-duplex operation.

In an eleventh aspect, alone or in combination with one or more of the first through tenth aspects, the full-duplex resource pattern indicates one or more of an RRC configured periodic or semi-persistent full-duplex resource pattern, or a MAC-CE or DCI indicated full-duplex resource pattern.

In a twelfth aspect, alone or in combination with one or more of the first through eleventh aspects, the dynamic CBSR configuration indicates a rank combination specific CBSR that configures the UE with a CBSR pattern associated with a rank combination, and the dynamic CBSR configuration reports at least two sets of ranks that are associated with two sets of CSI-RS or SSB resources.

In a thirteenth aspect, alone or in combination with one or more of the first through twelfth aspects, the time-variant CBSR information indicates a time-variant CBSR pattern, and the dynamic CBSR configuration indicates the rank combination specific CBSR and the time-variant CBSR pattern.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110) performs operations associated with dynamic CBSR configurations.

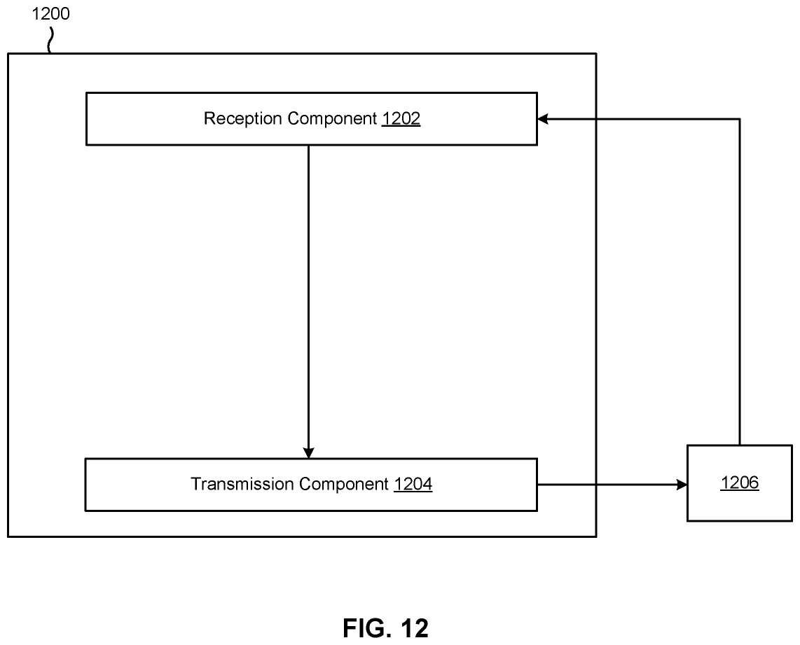

As shown in FIG. 10, in some aspects, process 1000 may include transmitting, to a UE, a dynamic CBSR configuration that indicates time-variant CBSR information associated with a CSI-RS or SSB resource selection codebook, or with a joint CSI-RS resource and CSI-RS port selection codebook (block 1010). For example, the base station (e.g., using transmission component 1204, depicted in FIG. 12) may transmit, to a UE, a dynamic CBSR configuration that indicates time-variant CBSR information associated with a CSI-RS or SSB resource selection codebook, or with a joint CSI-RS resource and CSI-RS port selection codebook, as described above.

As further shown in FIG. 10, in some aspects, process 1000 may include receiving, from the UE, CSI feedback that indicates the CSI-RS or SSB resource selection codebook or the joint CSI-RS resource and CSI-RS port selection codebook based at least in part on the dynamic CBSR configuration indicating the time-variant CBSR information (block 1020). For example, the base station (e.g., using reception component 1202, depicted in FIG. 12) may receive, from the UE, CSI feedback that indicates the CSI-RS or SSB resource selection codebook or the joint CSI-RS resource and CSI-RS port selection codebook based at least in part on the dynamic CBSR configuration indicating the time-variant CBSR information, as described above.

Process 1000 may include additional aspects, such as any single aspect or any combination of aspects described below and/or in connection with one or more other processes described elsewhere herein.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIGS. 6-8D. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive, from a base station, a dynamic CBSR configuration that indicates time-variant CBSR information associated with a CSI-RS or SSB resource selection codebook, or with a joint CSI-RS resource and CSI-RS port selection codebook. The transmission component 1104 may transmit, to the base station, CSI feedback that indicates the CSI-RS or SSB resource selection codebook or the joint CSI-RS resource and CSI-RS port selection codebook based at least in part on the dynamic CBSR configuration indicating the time-variant CBSR information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIGS. 6-8D. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

The transmission component 1204 may transmit, to a UE, a dynamic CBSR configuration that indicates time-variant CBSR information associated with a CSI-RS or SSB resource selection codebook, or with a joint CSI-RS resource and CSI-RS port selection codebook. The reception component 1202 may receive, from the UE, CSI feedback that indicates the CSI-RS or SSB resource selection codebook or the joint CSI-RS resource and CSI-RS port selection codebook based at least in part on the dynamic CBSR configuration indicating the time-variant CBSR information.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a base station, a dynamic codebook subset restriction (CBSR) configuration that indicates time-variant CBSR information associated with a channel state information reference signal (CSI-RS) or synchronization signal block (SSB) resource selection codebook, or with a joint CSI-RS resource and CSI-RS port selection codebook; and transmitting, to the base station, channel state information (CSI) feedback that indicates the CSI-RS or SSB resource selection codebook or the joint CSI-RS resource and CSI-RS port selection codebook based at least in part on the dynamic CBSR configuration indicating the time-variant CBSR information.

Aspect 2: The method of Aspect 1, wherein the time-variant CBSR information indicates a limitation pattern of an amplitude of a linear combination coefficient for a time unit.

Aspect 3: The method of Aspect 2, wherein the limitation pattern of the amplitude of the linear combination coefficient is associated with one or more selected CSI-RS or SSB resources for the CSI-RS or SSB resource selection codebook.

Aspect 4: The method of Aspect 2, wherein the limitation pattern of the amplitude of the linear combination coefficient is associated with CSI-RS ports associated with one or more selected CSI-RS or SSB resources for the joint CSI-RS resource and CSI-RS port selection codebook.

Aspect 5: The method of Aspect 2, wherein the time unit is based at least in part on one or more of: a symbol, a symbol group, a sub-slot, a half-slot, a slot, a mini-slot, a half-subframe, a subframe, a half-frame, or a frame.

Aspect 6: The method of Aspect 2, wherein the time unit is associated with a slot that indicates the CSI feedback, or wherein the time unit is associated with a slot with a configured offset associated with the slot that indicates the CSI feedback.

Aspect 7: The method of any of Aspects 1 through 6, wherein receiving the dynamic CBSR configuration that indicates the time-variant CBSR information is based at least in part on one or more of: radio resource control signaling, a medium access control control element, or downlink control information.

Aspect 8: The method of any of Aspects 1 through 7, wherein the time-variant CBSR information is configured or indicated based at least in part on radio resource control signaling that configures semi-statically or periodically applied CBSR patterns associated with different time units.

Aspect 9: The method of any of Aspects 1 through 8, wherein the time-variant CBSR information is configured or indicated based at least in part on: radio resource control signaling that configures multiple CBSR patterns associated with different time units, and a medium access control control element that activates or deactivates at least one of the multiple CBSR patterns.

Aspect 10: The method of any of Aspects 1 through 9, wherein the time-variant CBSR information is configured or indicated based at least in part on: radio resource control signaling that configures multiple CBSR patterns associated with different time units, and downlink control information that triggers or deactivates at least one of the multiple CBSR patterns.

Aspect 11: The method of any of Aspects 1 through 10, wherein the time-variant CBSR information indicates a full-duplex resource pattern, and wherein the full-duplex resource pattern is based at least in part on a CBSR usage dedicated for a base station full-duplex operation.

Aspect 12: The method of Aspect 11, wherein the full-duplex resource pattern indicates one or more of: a radio resource control configured periodic or semi-persistent full-duplex resource pattern, or a medium access control control element or downlink control information indicated full-duplex resource pattern.

Aspect 13: The method of any of Aspects 1 through 12, wherein the dynamic CBSR configuration indicates a rank combination specific CBSR that configures the UE with a CBSR pattern associated with a rank combination, and wherein the dynamic CBSR configuration reports at least two sets of ranks that are associated with two sets of CSI-RS or SSB resources.

Aspect 14: The method of Aspect 13, wherein the time-variant CBSR information indicates a time-variant CBSR pattern, and wherein the dynamic CBSR configuration indicates the rank combination specific CBSR and the time-variant CBSR pattern.

Aspect 15: A method of wireless communication performed by a base station, comprising: transmitting, to a user equipment (UE), a dynamic codebook subset restriction (CBSR) configuration that indicates time-variant CBSR information associated with a channel state information reference signal (CSI-RS) or synchronization signal block (SSB) resource selection codebook, or with a joint CSI-RS resource and CSI-RS port selection codebook; and receiving, from the UE, channel state information (CSI) feedback that indicates the CSI-RS or SSB resource selection codebook or the joint CSI-RS resource and CSI-RS port selection codebook based at least in part on the dynamic CBSR configuration indicating the time-variant CBSR information.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, from a base station, a dynamic codebook subset restriction (CBSR) configuration that indicates time-variant CBSR information associated with a channel state information reference signal (CSI-RS) or synchronization signal block (SSB) resource selection codebook, or with a joint CSI-RS resource and CSI-RS port selection codebook; and
transmitting, to the base station, channel state information (CSI) feedback that indicates the CSI-RS or SSB resource selection codebook or the joint CSI-RS resource and CSI-RS port selection codebook based at least in part on the dynamic CBSR configuration indicating the time-variant CBSR information.

2. The method of claim 1, wherein the time-variant CBSR information indicates a limitation pattern of an amplitude of a linear combination coefficient for a time unit.

3. The method of claim 2, wherein the limitation pattern of the amplitude of the linear combination coefficient is associated with one or more selected CSI-RS or SSB resources for the CSI-RS or SSB resource selection codebook.

4. The method of claim 2, wherein the limitation pattern of the amplitude of the linear combination coefficient is associated with CSI-RS ports associated with one or more selected CSI-RS or SSB resources for the joint CSI-RS resource and CSI-RS port selection codebook.

5. The method of claim 2, wherein the time unit is based at least in part on one or more of: a symbol, a symbol group, a sub-slot, a half-slot, a slot, a mini-slot, a half-subframe, a subframe, a half-frame, or a frame.

6. The method of claim 2, wherein the time unit is associated with a slot that indicates the CSI feedback, or wherein the time unit is associated with a slot with a configured offset associated with the slot that indicates the CSI feedback.

7. The method of claim 1, wherein receiving the dynamic CBSR configuration that indicates the time-variant CBSR information is based at least in part on one or more of: radio resource control signaling, a medium access control control element, or downlink control information.

8. The method of claim 1, wherein the time-variant CBSR information is configured or indicated based at least in part on radio resource control signaling that configures semi-statically or periodically applied CBSR patterns associated with different time units.

9. The method of claim 1, wherein the time-variant CBSR information is configured or indicated based at least in part on: radio resource control signaling that configures multiple CBSR patterns associated with different time units, and a medium access control control element that activates or deactivates at least one of the multiple CBSR patterns.

10. The method of claim 1, wherein the time-variant CBSR information is configured or indicated based at least in part on: radio resource control signaling that configures multiple CBSR patterns associated with different time units, and downlink control information that triggers or deactivates at least one of the multiple CBSR patterns.

11. The method of claim 1, wherein the time-variant CBSR information indicates a full-duplex resource pattern, and wherein the full-duplex resource pattern is based at least in part on a CBSR usage dedicated for a base station full-duplex operation.

12. The method of claim 11, wherein the full-duplex resource pattern indicates one or more of: a radio resource control configured periodic or semi-persistent full-duplex resource pattern, or a medium access control control element or downlink control information indicated full-duplex resource pattern.

13. The method of claim 1, wherein the dynamic CBSR configuration indicates a rank combination specific CBSR that configures the UE with a CBSR pattern associated with a rank combination, and wherein the dynamic CBSR configuration reports at least two sets of ranks that are associated with two sets of CSI-RS or SSB resources.

14. The method of claim 13, wherein the time-variant CBSR information indicates a time-variant CBSR pattern, and wherein the dynamic CBSR configuration indicates the rank combination specific CBSR and the time-variant CBSR pattern.

15. A method of wireless communication performed by a base station, comprising:
transmitting, to a user equipment (UE), a dynamic codebook subset restriction (CBSR) configuration that indicates time-variant CBSR information associated with a channel state information reference signal (CSI-RS) or synchronization signal block (SSB) resource selection codebook, or with a joint CSI-RS resource and CSI-RS port selection codebook; and
receiving, from the UE, channel state information (CSI) feedback that indicates the CSI-RS or SSB resource selection codebook or the joint CSI-RS resource and CSI-RS port selection codebook based at least in part on the dynamic CBSR configuration indicating the time-variant CBSR information.

16. An apparatus for wireless communication at a user equipment (UE), comprising:
a memory; and
one or more processors, coupled to the memory, configured to:
receive, from a base station, a dynamic codebook subset restriction (CBSR) configuration that indicates time-variant CBSR information associated with a channel state information reference signal (CSI-RS) or synchronization signal block (SSB) resource selection codebook, or with a joint CSI-RS resource and CSI-RS port selection codebook; and
transmit, to the base station, channel state information (CSI) feedback that indicates the CSI-RS or SSB resource selection codebook or the joint CSI-RS resource and CSI-RS port selection codebook based at least in part on the dynamic CBSR configuration indicating the time-variant CBSR information.

17. The apparatus of claim 16, wherein the time-variant CBSR information indicates a limitation pattern of an amplitude of a linear combination coefficient for a time unit.

18. The apparatus of claim 17, wherein the limitation pattern of the amplitude of the linear combination coefficient is associated with one or more selected CSI-RS or SSB resources for the CSI-RS or SSB resource selection codebook.

19. The apparatus of claim 17, wherein the limitation pattern of the amplitude of the linear combination coefficient is associated with CSI-RS ports associated with one or more selected CSI-RS or SSB resources for the joint CSI-RS resource and CSI-RS port selection codebook.

20. The apparatus of claim 17, wherein the time unit is based at least in part on one or more of: a symbol, a symbol group, a sub-slot, a half-slot, a slot, a mini-slot, a half-subframe, a subframe, a half-frame, or a frame.

21. The apparatus of claim 17, wherein the time unit is associated with a slot that indicates the CSI feedback, or wherein the time unit is associated with a slot with a configured offset associated with the slot that indicates the CSI feedback.

22. The apparatus of claim 16, wherein receiving the dynamic CBSR configuration that indicates the time-variant CBSR information is based at least in part on one or more of: radio resource control signaling, a medium access control control element, or downlink control information.

23. The apparatus of claim 16, wherein the time-variant CBSR information is configured or indicated based at least in part on radio resource control signaling that configures semi-statically or periodically applied CBSR patterns associated with different time units.

24. The apparatus of claim 16, wherein the time-variant CBSR information is configured or indicated based at least in part on: radio resource control signaling that configures multiple CBSR patterns associated with different time units, and a medium access control control element that activates or deactivates at least one of the multiple CBSR patterns.

25. The apparatus of claim 16, wherein the time-variant CBSR information is configured or indicated based at least in part on: radio resource control signaling that configures multiple CBSR patterns associated with different time units, and downlink control information that triggers or deactivates at least one of the multiple CBSR patterns.

26. The apparatus of claim 16, wherein the time-variant CBSR information indicates a full-duplex resource pattern, and wherein the full-duplex resource pattern is based at least in part on a CBSR usage dedicated for a base station full-duplex operation.

27. The apparatus of claim 26, wherein the full-duplex resource pattern indicates one or more of: a radio resource control configured periodic or semi-persistent full-duplex resource pattern, or a medium access control control element or downlink control information indicated full-duplex resource pattern.

28. The apparatus of claim 16, wherein the dynamic CBSR configuration indicates a rank combination specific CBSR that configures the UE with a CBSR pattern associated with a rank combination, and wherein the dynamic CBSR configuration reports at least two sets of ranks that are associated with two sets of CSI-RS or SSB resources.

29. The apparatus of claim 28, wherein the time-variant CBSR information indicates a time-variant CBSR pattern, and wherein the dynamic CBSR configuration indicates the rank combination specific CBSR and the time-variant CBSR pattern.

30. An apparatus for wireless communication at a base station, comprising:
a memory; and
one or more processors, coupled to the memory, configured to:
transmit, to a user equipment (UE), a dynamic codebook subset restriction (CBSR) configuration that indicates time-variant CBSR information associated with a channel state information reference signal (CSI-RS) or synchronization signal block (SSB) resource selection codebook, or with a joint CSI-RS resource and CSI-RS port selection codebook; and
receive, from the UE, channel state information (CSI) feedback that indicates the CSI-RS or SSB resource selection codebook or the joint CSI-RS resource and CSI-RS port selection codebook based at least in part on the dynamic CBSR configuration indicating the time-variant CBSR information.
